(19) United States
(12) Patent Application Publication
(10) Pub. No.: US 2021/0291779 A1
(43) Pub. Date: Sep. 23, 2021

(54) GAS GENERATOR AND METHOD FOR MANUFACTURING GAS GENERATOR

(71) Applicant: DAICEL CORPORATION, Osaka-shi, Osaka (JP)

(72) Inventors: Katsuhiro IMOTO, Tokyo (JP); Tomoharu KOBAYASHI, Tokyo (JP)

(73) Assignee: DAICEL CORPORATION, Osaka-shi, Osaka (JP)

(21) Appl. No.: 17/262,445

(22) PCT Filed: Jun. 13, 2019
(86) PCT No.: PCT/JP2019/023494

§ 371 Date: Jan. 22, 2021

(30) Foreign Application Priority Data
Jul. 24, 2018 (JP) 2018-138193

(51) Int. Cl. B60R 21/264; B60R 21/261

(52) U.S. Cl. CPC B60R 21/264; B60R 2021/26076; B60R 21/261

(57) ABSTRACT

A gas generator includes a housing, a combustion chamber accommodating therein a gas generating agent burned by an ignition device, a plurality of gas discharge ports provided to a wall surface that defines the combustion chamber, and communicating an inside and an outside of the combustion chamber, and a plurality of closing members respectively closing the plurality of gas discharge ports. Each of the plurality of closing members includes a covering region covering a corresponding gas discharge port of the plurality of gas discharge ports, and a joining region being joined to the wall surface of the housing, and formed adjacent to and surrounding the covering region. The joining region of each of the plurality of closing members is joined to the wall surface at a width within a range from 1 mm to 5 mm, inclusive, from a peripheral edge of the corresponding gas discharge port, and without interfering with another joining region.

### FIELD

The present invention relates to a gas generator configured to burn a gas generating agent by explosive combustion at an igniter and generate combustion gas.

### BACKGROUND

A gas generator configured to burn a gas generating agent and supply the generated combustion gas as a power source for realizing a desired operation is known. The gas generator burns the gas generating agent inside a housing by actuation of an igniter, and supplies the generated combustion gas to the outside from a gas discharge port provided to the housing. In such a gas generator, prior to actuation of the igniter, the gas discharge port is closed, and thus outside air containing moisture does not enter the housing from the gas discharge port and get the gas generating agent wet.

Patent Document 1 describes a gas generator in which a plurality of gas-jetting ports are provided to a peripheral wall of an upper shell constituting a housing. In the gas generator, the plurality of gas-jetting ports are closed by a single sealing tape having a strip shape and a constant width. The sealing tape is adhered to an inner peripheral surface of the peripheral wall of the upper shell, closing the gas-jetting ports. The sealing tape ensures an air tightness of the combustion chamber inside the housing. Further, when the igniter of the gas generator is actuated, the sealing tape of portions where the gas-jetting ports are closed raptures as a pressure inside the housing rises due to combustion of the gas generating agent, thereby opening the gas-jetting ports and supplying combustion gas to the outside.

### CITATION LIST

[Patent Document]

Patent Document 1: WO 2015/163290

### SUMMARY

### Technical Problem

When a plurality of gas-jetting ports are provided side by side to a peripheral wall of a housing, the plurality of gas-jetting ports can be closed by a single sealing tape having a strip shape and a constant width. Further, the sealing tape having a strip shape is formed with the width thereof being wide enough to have a margin after the gas-jetting portions are closed. Therefore, the sealing tape is also adhered to a region of the inner peripheral surface of the peripheral wall of the housing other than the region where the gas-jetting ports are formed. Of the entire region covered by the sealing tape, an area of the peripheral wall where the gas-jetting ports are not formed is larger than an area of all openings of the gas-jetting ports.

When the igniter of the gas generator is actuated and the gas generating agent is burned, the sealing tape is exposed to high temperatures and the sealing tape may melt. A portion of the entire region of the sealing tape that actually closes the gas-jetting ports raptures in the initial period of actuation of the gas generator, and thus the time of exposure to high temperature is shorter than the time required for melting, preventing melting. However, a portion of the entire region of the sealing tape adhered to the peripheral wall of the housing is exposed to high temperatures for a longer period of time during actuation of the gas generator, and may melt and be released to outside the gas generator along with the combustion gas. With the area of the strip-shaped sealing tape adhered to the inner peripheral surface where the gas-jetting ports are not formed being larger than the area of the portions that close the gas-jetting ports, the sealing tape contains a relatively greater number of portions that may melt than portions that may not melt during combustion of the gas generating agent. Therefore, there is high risk that the sealing tape melted during combustion of the gas generating agent will be released to the outside. A sealing tape that melts and is released from the gas generator is not preferred for devices that use combustion gas as a power source.

In light of the problems described above, an object of the present disclosure is to provide a technique that closes a gas discharge port of a gas generator by a closing member and is capable of suppressing the melting of the closing member and the release thereof to outside the gas generator during combustion of a gas generating agent.

### Solution to Problem

In order to solve the problems described above, a gas generator according to the present disclosure employs a configuration in which a gas discharge port is closed by a closing member including a covering region configured to cover the gas discharge port and a joining region configured to be joined to a wall surface defining a combustion chamber and formed adjacent to and surrounding the covering region. With such a configuration, it is possible to close the gas discharge port and suppress the release of a melted closing member to outside the gas generator.

Specifically, a gas generator according to the present disclosure includes a housing, a combustion chamber accommodating therein a gas generating agent to be burned by an ignition device provided in the housing, a plurality of gas discharge ports provided to a wall surface that defines the combustion chamber, and configured to communicate an inside and an outside of the combustion chamber, and a plurality of closing members configured to respectively close the plurality of gas discharge ports. Then, each of the plurality of closing members includes a covering region configured to cover a corresponding gas discharge port of the plurality of gas discharge ports and a joining region configured to be joined to the wall surface and formed adjacent to and surrounding the covering region. Furthermore, the joining region of each of the plurality of closing members is joined to the wall surface at a width within a range from 1 mm to 5 mm, inclusive, from a peripheral edge of the corresponding gas discharge port, and without interfering with another joining region.

The gas generator according to the present disclosure burns the gas generating agent by actuation of the ignition device, thereby generating combustion gas. Then, the gas generator supplies the combustion gas as a predetermined drive source. Here, in the gas generator, prior to actuation of the ignition device, the gas discharge ports are closed by the closing members, and thus outside air does not enter the combustion chamber. Thus, an air tightness inside the combustion chamber is ensured. When the ignition device is actuated, a pressure inside the combustion chamber rises due to the generation of combustion gas and the covering regions of the closing members rapture, communicating the outside with the inside of the combustion chamber and supplying the combustion gas to the outside through the gas discharge ports. The covering regions of the closing members rapture in the initial period of actuation of the ignition device, and thus the time exposed to high temperatures is shorter than the time required for melting, preventing melting. On the other hand, the joining regions of the closing members remain joined to the wall surface defining the combustion chamber even after the covering regions rapture, and the joining regions are brought into a high temperature state during combustion of the gas generating agent.

Here, in the gas generator according to the present disclosure, the joining region of each of the plurality of closing members is joined to the wall surface defining the combustion chamber at a width within a range from 1 mm to 5 mm from the peripheral edge of the corresponding gas discharge port. The joining regions are not provided wider than necessary for ensuring the air tightness of the combustion chamber, making it possible to reduce the possibility of the melting of the closing members. Thus, the gas generator according to the present disclosure is capable of closing the gas discharge ports by the closing members and suppressing the melting of the closing members and the release thereof to the outside during combustion of the gas generating agent.

The combustion chamber may be defined by the housing or may be defined by an inner partition wall disposed inside the housing. In a case where the combustion chamber is defined by the housing, the gas discharge ports are provided to the wall surface of the housing. Further, in a case where the combustion chamber is defined by the inner partition wall disposed inside the housing, the gas discharge ports are provided penetrating the inner partition wall.

Further, in the gas generator described above, each of the plurality of closing members may have an outer shape similar to a shape of each of the plurality of gas discharge ports. With such a configuration, in a case where the closing members are to be disposed in correspondence with the gas discharge ports, the closing members can be easily positioned. Further, a joining force of the closing member to the wall surface can be maintained while minimizing an area of the joining region. Note that the outer shape of the closing members and the shape of the gas discharge ports may be circular, polygonal, elliptical, or the like.

Further, in the gas generator described above, each of the plurality of closing members may be attached to the wall surface on a side of the combustion chamber. With such a configuration, when the ignition device is actuated and the gas generating agent is burned, the joining regions of the closing members are exposed to high temperatures. However, because the joining regions are not provided wider than necessary for ensuring the air tightness of the combustion chamber, the joining regions that may melt are made smaller in size, making it possible to reduce the possibility of the melting of the closing members. Further, the closing member readily raptures by shear force, making it possible to obtain a stable opening area in the gas discharge port after the covering region raptures.

Further, in the gas generator described above, each of the plurality of closing members may have a center position that coincides with a center position of the corresponding gas discharge port. With such a configuration, a width of the joining region of the closing member can be made constant, and the entire peripheral edge of the gas discharge port can be uniformly sealed.

Further, in the gas generator described above, each of the plurality of gas discharge ports may be disposed in a circumferential direction of the housing, each of the plurality of closing members may be joined to the wall surface by the joining region of the closing member and by a connecting member in a state where adjacent closing members of the plurality of closing members are connected and integrated by the connecting member, and the connecting member may have a width smaller than a width of each of the plurality of closing members. According to such a configuration, the closing member can be attached by the joining region and the connecting member, making it possible to more firmly fix the closing member. Further, the connecting member has a width smaller than the width of each of the plurality of closing members, and thus an area of the closing members and the connecting members can be made smaller than an area of the sealing tape having a strip shape, and an area of the closing members and the connecting members that may melt can be reduced, making it possible to suppress the melting of the closing members and the connecting members and the release thereof to the outside during combustion of the gas generating agent. Furthermore, a flexibility of the connecting member can be utilized to make the occurrence of distortion and displacement of the closing member, which may arise during adherence of the closing member, less likely, making it possible to suppress the occurrence of wrinkles and gaps between the closing member and the wall surface after the closing member is completely adhered compared to a case where a sealing tape having a strip shape and a constant width is used to close the gas discharge ports.

Furthermore, in the gas generator described above, each of the plurality of closing members may be a sealing tape. For example, as the closing member, a sealing tape having an adhesive layer formed on one surface of aluminum foil or other metal foil may be used.

Here, the technique of the present disclosure can be considered from an aspect of a method for manufacturing a gas generator. In other words, the technique of the present disclosure is a method for manufacturing the gas generator described above. Specifically, the method includes preparing a sealing member provided with, on a base material including one surface provided with a joining surface that can be joined to the wall surface, the plurality of closing members independently formed correspondingly to each arrangement of the plurality of gas discharge ports provided to the wall surface, each of the plurality of closing members being formed by being coupled to the base material at a strength lower than a strength of the base material, adhering the sealing member to the wall surface with each of the plurality of closing members formed on the sealing member made to respectively correspond to the plurality of gas discharge ports, and closing each of the plurality of gas discharge ports while peeling the base material from the sealing member adhered to the wall surface, leaving each of the plurality of closing members on the wall surface with the joining region of each of the plurality of closing members joined to the wall surface.

In the method for manufacturing the gas generator described above, after the single sealing member is adhered to the wall surface, the base material is peeled from the sealing member, closing each of the plurality of gas discharge ports by each of the plurality of closing members. This makes it possible to shorten the time required for attaching the closing members, and complete the closing of the gas discharge ports in a short amount of time.

### Advantageous Effects of Invention

According to the technique of the present disclosure, it is possible to provide a technique that closes a gas discharge port of a gas generator by a closing member and is capable of suppressing the melting of the closing member and the release thereof to outside the gas generator when a gas generating agent is burned.

### BRIEF DESCRIPTION OF DRAWINGS

FIG. 1 is a drawing illustrating a schematic configuration of a gas generator according to a first example of the present embodiment.

FIG. 2 is a drawing illustrating a closing member of the gas generator according to the first example of the present embodiment.

FIG. 3 is a drawing illustrating the closing member of the gas generator according to the first example of the present embodiment.

FIG. 4 is a flowchart illustrating a method for manufacturing the gas generator according to the first example of the present embodiment.

FIG. 5 is a drawing illustrating the method for manufacturing the gas generator according to the first example of the present embodiment.

FIG. 6 is a drawing illustrating the closing member of a gas discharge port according to a modified example of the first example of the present embodiment.

FIG. 7 is a drawing illustrating a schematic configuration of a gas generator according to a second example of the present embodiment.

### DESCRIPTION OF EMBODIMENTS

A gas generator according to an embodiment of the present disclosure will be described below with reference to the drawings. Note that configurations of the following embodiment are provided as examples, and the technique of the present disclosure is not limited to the configurations of the embodiment.

### First Example

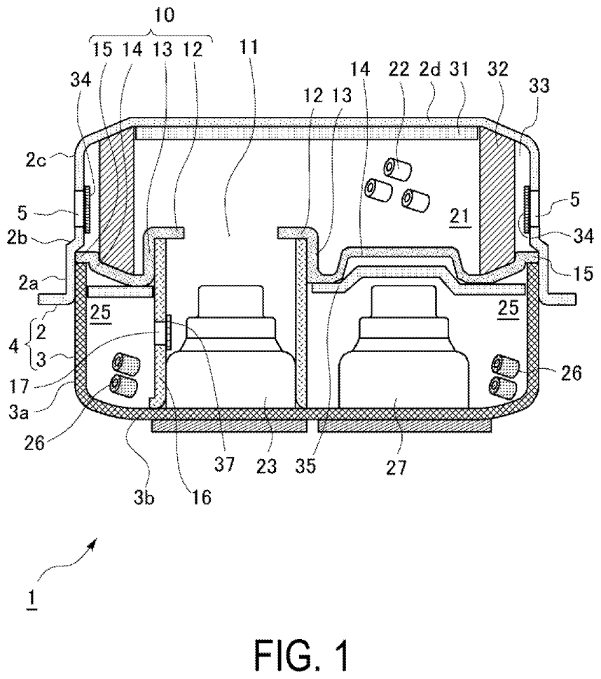

FIG. 1 is a cross-sectional view in a height direction of a gas generator 1 according to a first example. The gas generator 1 is configured to burn a gas generating agent with which a housing 4, formed by an upper shell 2 and a lower shell 3, is filled and to release a combustion gas. Note that the gas generator 1 is a so-called dual-type gas generator including two combustion chambers disposed on an upper side and a lower side, respectively, and each of the two combustion chambers includes an igniter and a gas generating agent corresponding thereto, as described below. Here, the upper shell 2 includes a peripheral wall 2c and a top surface 2d which form a recessed internal space. The top surface 2d together with a bottom surface 3b of the lower shell 3 described below have a substantially circular shape in a top view. The peripheral wall 2c and a peripheral wall 3a of the lower shell 3 described below surround the top surface 2d and the bottom surface 3b, respectively, and extend substantially perpendicularly from the corresponding surfaces to form annular wall surfaces. The internal space of the upper shell 2 is a first combustion chamber 21 filled with a first gas generating agent 22, as described below. The top surface 2d is connected to one end of the peripheral wall 2c, and the other end of the peripheral wall 2c serves as an opening of the upper shell 2. Further, on the other end of the peripheral wall 2c, a mating wall 2a and an abutting portion 2b are provided in this order from the opening. The radius of the internal space formed by the mating wall 2a is larger than the radius of the internal space formed by the peripheral wall 2c on a side nearer to the top surface 2d, and the mating wall 2a connects to the peripheral wall 2c, with the abutting portion 2b interposed therebetween.

Furthermore, the lower shell 3 includes the peripheral wall 3a and the bottom surface 3b which form a recessed internal space. The internal space is a second combustion chamber 25 filled with a second gas generating agent 26. The bottom surface 3b is connected to one end of the peripheral wall 3a, and the other end of the peripheral wall 3a serves as an opening of the lower shell 3. The radius of the internal space formed by the peripheral wall 3a is substantially the same as the radius of the internal space formed by the peripheral wall 2c of the upper shell 2. The bottom surface 3b of the lower shell 3 is provided with a hole in which a first igniter 23 is fixed and a hole in which a second igniter 27 is fixed.

Further, in the housing 4, a divider wall 10 is disposed between the upper shell 2 and the lower shell 3. The divider wall 10 includes a terminating end 15, a dividing wall 14 connected to the terminating end 15 and substantially dividing the inside of the housing 4 into upper and lower spaces, a peripheral wall 13 connected to the dividing wall 14 and extending along an accommodating wall member (accommodating wall) 16 described below, and an end 12 disposed partially covering the opening of the accommodating wall member 16. Note that the end 12 forms a through hole 11. Further, the accommodating wall member 16 having a tubular shape is provided on the bottom surface 3b, surrounding the periphery of the first igniter 23 attached to the bottom surface 3b of the lower shell 3 in the height direction thereof. An opening above the accommodating wall member 16 is covered by the end 12 of the divider wall 10. In addition, a through hole 17 is provided in the accommodating wall member 16, and the through hole 17 allows communication between two spaces (the first combustion chamber 21 and the second combustion chamber 25) resulting from division by the divider wall 10. The through hole 17 is closed by a closing member 37 from the side where the first igniter 23 is arranged. As the closing member 37, the same member as that of a closing member 34 is used.

An interior of the accommodating wall member 16 having a tubular shape and surrounding the first igniter 23 may be filled with a transfer charge. Examples of the transfer charge include a granular or cylindrical transfer charge containing, for example, nitroguanidine (34 wt. %) and strontium nitrate (56 wt. %). Further, when the interior is filled with the transfer charge, the through hole 11 is closed by aluminum tape or the like, and mixture of the transfer charge and the first gas generating agent 22 is prevented. The gas generator 1 according to the present example includes the first igniter 23 as an ignition device. The ignition device may be constituted by the first igniter 23 only, or may be configured to include the first igniter 23 and the transfer charge.

In a state where the divider wall 10 is thus attached on the lower shell 3, the upper shell 2 is further attached from above. As described above, since the radius of the internal space formed by the mating wall 2a of the upper shell 2 is larger than the radius of the internal space formed by the peripheral wall 2c, the upper shell 2 is mated with the lower shell 3, and thus the abutting portion 2b is abutted on the terminating end 15 of the divider wall 10. Note that, in the housing 4, at a site of mating or contact between the upper shell 2 and the lower shell 3, the upper shell 2 and the lower shell 3 are joined by any joining method (for example, welding or the like) suitable in terms of moisture prevention and the like for the gas generating agent filled in the housing 4.

As described above, the internal space of the housing 4 is substantially divided, by the divider wall 10, into two spaces positioned on the upper side and the lower side, respectively. In the internal space of the housing 4, in the first combustion chamber 21 defined by the upper shell 2 and the divider wall 10, there are the first igniter 23, and the first gas generating agent 22, and in the second combustion chamber 25 defined by the lower shell 3 and the divider wall 10, there are the second igniter 27 and the second gas generating agent 26. In this way, the gas generator 1 is configured as a dual-type gas generator including two igniters, i.e., the first igniter 23 and the second igniter 27. Note that the first igniter 23 and the second igniter 27 are both fixed on the bottom surface 3b of the lower shell 3, and thus the first igniter 23 is housed in a state in which the side of the first igniter 23 is surrounded by the accommodating wall member 16.

Here, while, in the first combustion chamber 21, the first igniter 23 is accommodated in the internal space of the accommodating wall member 16 (the space defined by an inner side of the accommodating wall member 16 and the bottom surface 3b of the lower shell 3 and opening upward), and the space thereabove is filled with the first gas generating agent 22, a filter 32 having an annular shape is disposed surrounding the first gas generating agent 22. At this time, the first gas generating agent 22 is filled in a state of being pressed, by a biasing force applied by a cushion 31, against the filter 32, the dividing wall 14, and the like, and thus undesired vibration of the first gas generating agent 22 in the first combustion chamber 21 does not occur. The first gas generating agent 22 used is a gas generating agent having a relatively low combustion temperature. It is preferable that the first gas generating agent 22 has a combustion temperature in the range from 1000 to 1700° C. As the first gas generating agent 22, a single hole cylindrical gas generating agent including guanidine nitrate (41 wt. %), basic copper nitrate (49 wt. %), and a binder and an additive, for example, may be used. Note that the internal space of the accommodating wall member 16 may be filled with a gas generating agent having a different composition from that of the first gas generating agent 22. In this case, the composition of the gas generating agent filled in the internal space of the accommodating wall member 16 can be configured with the combustion temperature higher than the combustion temperature of the first gas generating agent 22 to promote ignition of the first gas generating agent 22.

The filter 32 is configured by stacking flat woven meshes made of stainless steel in the radial direction and compressing the meshes in the radial and axial directions. The filter 32 is configured to cool the combustion gas from the first gas generating agent 22 and collect combustion residue included in the combustion gas. Alternatively, a filter having a wire-wound-type structure, in which a wire is wound forming multiple layers on a core rod, may be used as the filter 32. Note that the filter 32 also collects the combustion residue of the second gas generating agent 26 filled in the second combustion chamber 25. In addition, a gap 33 formed between the peripheral wall 2c of the upper shell 2 and the filter 32 forms a gas passage that surrounds the filter 32 and has an annular shape in the radial direction in cross sectional view. The gap 33 allows the combustion gas to pass through the entire area of the filter 32, and thus it is possible to achieve effective utilization of the filter 32 and effective cooling and purification of the combustion gas. The combustion gas flowing through the gap 33 reaches a gas discharge port 5 provided in the peripheral wall 2c. In addition, to prevent outside air containing moisture from entering the housing 4 from the outside, the gas discharge port 5 is closed, by the closing member 34, from the inside the housing 4 until the gas generator 1 is actuated. In the present example, a plurality of the gas discharge ports 5 are provided to a wall surface of the peripheral wall 2c defining the first combustion chamber 21, and the plurality of gas discharge ports 5 are respectively closed by a plurality of the closing members 34. The closing members 34 are each attached to an inner wall surface of the peripheral wall 2c of the upper shell 2, closing the gas discharge ports 5 from inside of the housing 4. In addition, the closing members 34 are each disposed exposed to the first combustion chamber 21 via the filter 32. Note that the closing member 34 will be described in detail below.

Further, the second combustion chamber 25 is filled with the second gas generating agent 26 correspondingly to the second igniter 27 fixed to the bottom surface 3b of the lower shell 3. Further, the second gas generating agent 26 is also filled in a state of being biased by a cushion 35, and thus undesired vibration of the second gas generating agent 26 in the second combustion chamber 25 does not occur. Further, similar to the first gas generating agent 22, for the second gas generating agent 26 as well, a single hole cylindrical gas generating agent including guanidine nitrate (41 wt. %), basic copper nitrate (49 wt. %), and a binder and an additive, for example, may be used.

In addition, an area surrounding the second igniter 27 may be filled with a transfer charge. Examples of the transfer charge include a granular or cylindrical transfer charge containing, for example, nitroguanidine (34 wt. %) and strontium nitrate (56 wt. %). In addition, when the area is filled with a transfer charge, a predetermined member that isolates the transfer charge and the second gas generating agent 26 is arranged, ensuring that the transfer charge and the second gas generating agent 26 are not mixed. The gas generator 1 according to the present example includes the second igniter 27 as an ignition device. The ignition device may be constituted by the second igniter 27 only, or may be configured to include the second igniter 27 and the transfer charge.

In the present example, the combustion chambers 21, 25 are defined by the housing 4. Note that a member including an inner partition wall having an annular shape may be disposed inside a housing 104, the inner partition wall may be filled with the gas generating agents 21, 26, and the combustion chambers 21, 25 may be defined by the inner partition wall. In this case, the gas discharge ports are provided penetrating the inner partition wall, and the closing members 34 are attached to the inner partition wall.

With such a configuration, in the gas generator 1, the release mode of the combustion gas to the outside can be variously adjusted by the combustion of the first gas generating agent 22 caused by actuation of the first igniter 23 and combustion of the second gas generating agent 26 caused by actuation of the second igniter 27. Further, the gas generator 1 can also generate and release to the outside a relatively large amount of combustion gas.

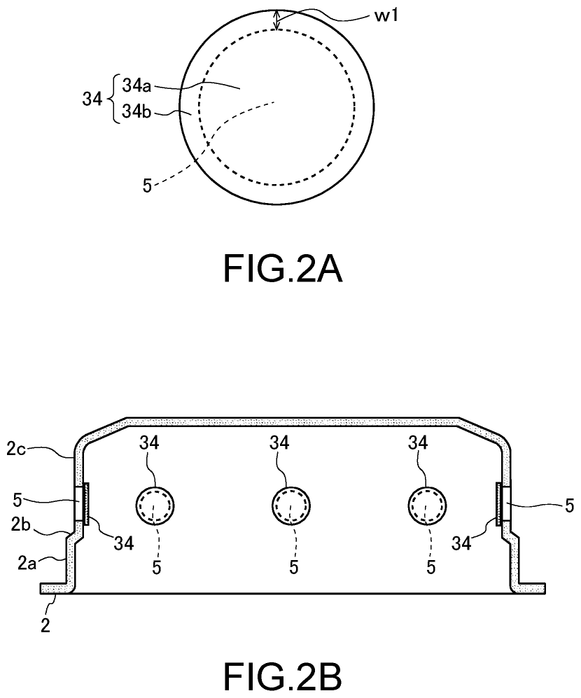

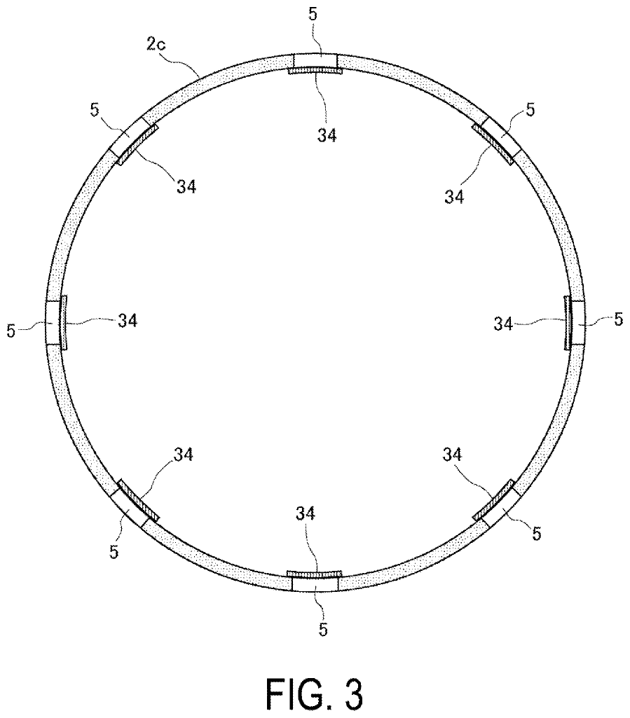

Next, the gas discharge port 5 and the closing member 34 are described in detail using FIG. 2 and FIG. 3, with reference to FIG. 1. FIG. 2(a) is an extracted, enlarged plan view illustrating the gas discharge port 5 and the closing member 34 provided to a wall surface of the upper shell 2 defining the first combustion chamber 21. FIG. 2(b) is a cross-sectional view illustrating the upper shell 2 and the closing members 34 extracted from the cross-sectional view in the height direction of the gas generator 1 illustrated in FIG. 1. In FIGS. 2(a) and (b), a region surrounded by a dotted line is the gas discharge port 5. The gas discharge port 5 communicates the inside and the outside of the housing 4, and is provided for supplying combustion gas to the outside of the housing during combustion of the gas generating agents 22, 26. In the present example, each of the plurality of gas discharge ports 5 is disposed in a circumferential direction of the upper shell 2. In addition, each of the plurality of gas discharge ports 5 is formed to a same size and into a same shape. In the present example, the gas discharge port 5 is formed into a circular shape. Note that the gas discharge port 5 may be formed into an elliptical shape or a polygonal shape. In addition, the plurality of gas discharge ports 5 are disposed at equal intervals.

In addition, as illustrated in FIGS. 2(a) and (b), one gas discharge port 5 is closed by one closing member 34. In the present example, each of the plurality of closing members is attached to the wall surface (inner wall surface) of the peripheral wall 2c on a side of the combustion chamber 21. The closing member 34 includes a covering region 34a configured to cover the gas discharge port 5, and a joining region 34b configured to be joined to the wall surface of the peripheral wall 2c of the upper shell 2, and formed adjacent to and surrounding the covering region 34a. In FIGS. 2(a) and (b), the region surrounded by a dotted line is the covering region 34a, and the region outside the dotted line and surrounded by a solid line is the joining region 34b. The covering region 34a is a region overlapping the gas discharge port 5 and is a portion covering the gas discharge port 5. The joining region 34b is a portion serving as an attachment allowance when the closing member 34 is attached to the peripheral wall 2c. The joining region 34b is joined to the wall surface of the peripheral wall 2c, thereby sealing an entire peripheral edge of the gas discharge port 5. Thus, the closing member 34 closes the gas discharge port 5.

The closing member 34 is attached to prevent outside air from entering the housing 4 via the gas discharge port 5. The air tightness of the internal space of the housing 4 is ensured by the closing member 34. Therefore, the entire peripheral edge of the gas discharge port 5 needs to be reliably sealed by the joining region 34b of the closing member 34. When a width w1 of the joining region 34b is too narrow, it may not be possible to reliably seal the entire peripheral edge of the gas discharge port 5. Therefore, in the present example, the width w1 of the joining region 34b of the closing member 34 illustrated in FIG. 2(a) is set to 1 mm or greater. More specifically, a lower limit of the width w1 of the joining region 34b is set to 0.95 mm with two significant digits. Note that the width w1 of the joining region 34b is a length from the peripheral edge of the gas discharge port 5 to a peripheral edge of the closing member 34. In addition, the joining region 34b is a portion where the time of exposure to high temperatures inside the housing 4 increases when the gas generating agents 22, 26 are burned during actuation of the igniters 23, 27 of the gas generator 1. When the width w1 of the joining region 34b is wider than the width necessary for sealing the entire peripheral edge of the gas discharge port 5, the portion that may melt during actuation of the gas generator 1 is made wider than necessary, which is not preferable. Therefore, in the present example, the width w1 of the joining region 34b is set to 5 mm or less. More specifically, an upper limit of the width w1 of the joining region 34b is set to 5.4 mm with two significant digits. In addition, when the joining region 34b of another closing member adjacent thereto overlaps the joining region 34b, the joining properties of the joining region 34b may deteriorate or a gap may be formed at an end of the portion where the joining regions 34b overlap, thereby reducing the sealing properties of the gas discharge port 5. Therefore, in the present example, the joining region 34b of one closing member 34 is attached without overlapping or coming into contact with the joining region 34b of another closing member 34. That is, the joining region 34b of one closing member 34 is disposed on the wall surface of the peripheral wall 2c without interfering with the joining region 34b of another closing member 34. In this way, in the present example, each of the plurality of closing members 34 is disposed independently of the closing member 34 adjacent thereto.

As the closing member 34, for example, a sealing tape including an adhesive layer formed on one side of aluminum foil having a thickness of about 50 to 100 μm is used. Note that, as the closing member 34, a sealing tape having an adhesive layer formed on one side of a metal foil other than aluminum foil may be used, or an adhesive may be applied to one side of a metal foil and the metal foil may be adhered to the housing 4 to form the closing member 34.

In the present example, an outer shape of the closing member 34 is formed into circular shape. The outer shape of the closing member 34 is similar to the shape of the gas discharge port 5. In addition, the closing member 34 is disposed with a center thereof coincident with a center of the gas discharge port 5. In other words, the closing member 34 is disposed concentrically with the gas discharge port 5. Therefore, the width w1 of the joining region 34b is constant in a circumferential direction of the gas discharge port 5. By making the width w1 of the joining region 34b constant, it is possible to uniformly seal the entire peripheral edge of the gas discharge port 5. The outer shape of the closing member 34 need not be similar to that of the gas discharge port 5, and may be formed into an oval shape or a polygonal shape, for example. In addition, the width w1 of the joining region 34b need not be constant in the circumferential direction of the gas discharge port 5, and may be from 1 mm (0.95 mm) to 5 mm (5.4 mm or less).

FIG. 3 is an end surface view including the peripheral wall 2c and the closing members 34, with the gas generator 1 cut in a horizontal direction (direction orthogonal to the height direction). In the gas generator 1 according to the present example, eight gas discharge ports 5 are disposed in a circumferential direction of the peripheral wall 2c. In addition, in the present example, the respective sizes and shapes of the plurality of gas discharge ports 5 are all formed in the same manner. Note that, in the gas generator 1, the respective shapes and sizes of the plurality of gas discharge ports 5, and a quantity, an arrangement interval, and an arrangement pattern of the gas discharge ports 5 can be variously changed in consideration of output characteristics of the generated combustion gas. Further, each of the plurality of closing members 34 may have a different tensile strength to differentiate a burst pressure of each of the closing members 34. The tensile strengths of the closing members 34 can vary depending on the thickness and the forming material.

Further, in the present example, as illustrated in FIG. 3, one closing member 34 closes one gas discharge port 5 only. Thus, the one closing member 34 that closes one gas discharge port 5 is independent from another closing member 34 that closes another gas discharge port 5.

Next, the operation of the gas generator 1 according to the present example will be described with reference to FIG. 1. First, in the gas generator 1, the first igniter 23 is actuated, causing the first gas generating agent 22 inside the first combustion chamber 21 to burn. As a result, combustion gas is generated inside the first combustion chamber 21, and the pressure inside the first combustion chamber 21 rises. Due to the rise in pressure inside the first combustion chamber 21, the covering regions 34a of the closing members 34 that close the gas discharge ports 5 rapture, and the inside and the outside of the housing 4 are communicated by the gas discharge ports 5. The combustion gas generated by the first gas generating agent 22 reaches the gas discharge ports 5 through the filter 32, and is supplied to the outside of the gas generator 1 though the gas discharge ports 5. In the present example, the closing members 34 are attached to the inner wall surface of the peripheral wall 2c, and thus readily rapture by shear force, making it possible to obtain stable opening areas of the gas discharge ports 5 after the covering regions 34a rapture.

Next, the second igniter 27 is actuated, causing the second gas generating agent 26 inside the second combustion chamber 25 to burn. As a result, combustion gas is generated inside the second combustion chamber 25, and the pressure inside the second combustion chamber 25 rises. Due to the rise in pressure inside the second combustion chamber 25, the closing members 37 that close the through holes 17 rapture, and the first combustion chamber and the second combustion chamber are communicated. The combustion gas generated by the second gas generating agent 26 reaches the gas discharge ports 5 through the through holes 17, the first combustion chamber 21, and the filter 32, and is supplied to the outside of the gas generator 1 though the gas discharge ports 5. Thus, the gas generator 1 can release the combustion gas to the outside by the combustion of the first gas generating agent 22 by actuation of the first igniter 23 and the combustion of the second gas generating agent 26 by actuation of the second igniter 27. Note that, the actuation timing of each igniter is determined in accordance with the output characteristics of the combustion gas required for the gas generator 1.

During actuation of the gas generator 1, the covering regions 34a rapture by shear force during the initial period of actuation of the gas generator 1, leaving the joining regions 34b, and thus the time exposed to high temperatures is shorter than the time required for melting, preventing melting. On the other hand, the joining regions 34b of the closing members 34 remain adhered to the inner wall surface of the peripheral wall 2c even after the covering regions 34a rapture, and the joining regions 34b are brought into high temperature states during the combustion of the first gas generating agent 22 and the second gas generating agent 26. In the gas generator 1 according to the present example, the joining regions 34b are not provided wider than necessary for ensuring the air tightness of the internal space of the housing 4, making it possible to reduce the possibility of the melting of the closing members 34. Thus, with the gas generator 1 according to the present example, it is possible to close the gas discharge ports 5 by the closing members 34 and suppress the melting of the closing members 34 and the release thereof to outside the housing 4 during combustion of the gas generating agents 22, 26. Further, because the regions of the joining regions 34b of the closing members 34 are relatively small, the occurrence of wrinkles that arise during a temperature change due to a difference in expansion rate between the housing 4 and the closing members 34 is reduced, making it possible to prevent the occurrence of gaps between the housing 4 and the closing members 34. Further, the outer shape of the closing members 34 is similar to the shape of the gas discharge ports 5, and thus the joining force to the wall surface of the peripheral wall 2c of the closing members 34 can be maintained while minimizing the area of the joining regions 34b.

Generally, a gas generator can be utilized as a power source for deploying an airbag of an airbag device mounted in an automobile or the like, for example. When a gas generator is utilized as a power source for an airbag device, it is not preferable, for an airbag, that a lump of molten sealing tape is released to the outside together with the combustion gas.

On the other hand, in the gas generator 1 according to the present example, the member that closes the gas discharge port 5 includes the covering region 34a and the joining region 34b, and the joining region 34b is not provided wider than necessary, making it possible to reduce the possibility of the melting of the closing member 34. Thus, when the gas generator 1 according to the present example is utilized as a power source of an airbag device, it is possible to suppress the release of a melted closing member into the airbag.

Further, the same member as the closing member 34 can also be used for the closing member 37 that closes the through hole 17 communicating the first combustion chamber 21 with the second combustion chamber 25. When a sealing tape having a strip shape is used to close the through hole 17, a portion of the sealing tape adhered to the wall surface of the accommodating wall member 16 is exposed to high temperatures during combustion of the gas generating agents 22, 26, and may melt and be released toward the gas discharge ports 5 together with the combustion gas. The melted sealing tape is collected by the filter 32. However, when the melted sealing tape is in a state that allows passage through a filter, the melted sealing tape may pass through the filter 32 and be discharged from the gas discharge ports 5 to the outside. In the present example, the same member as the closing member 34 is used for the closing member 37. The closing member 37 includes a covering region configured to cover the through hole 17 and a joining region configured to be joined to the wall surface of the accommodating wall member 16 and formed adjacent to and surrounding the covering region. The joining region of the closing member 37 is joined to the wall surface at a width within a range from 1 mm to 5 mm, inclusive, from a peripheral edge of the through hole 17, and without interfering with another joining region. The joining region of the closing member 37 is not provided wider than necessary, making it possible to reduce the possibility of the melting of the closing member 37. Thus, with the gas generator 1 according to the present example, it is possible to suppress the melting of the closing member 37 and the release thereof to outside the housing 4 during combustion of the gas generating agents 22, 26. In particular, while the accommodating wall member 16 has a greater curvature than the peripheral wall 2c of the housing 4 and thus, when the closing member 37 is adhered to the accommodating wall member 16, wrinkles may readily occur in the closing member 37, the area of the joining region 34b of the closing member 37 is minimized, making it possible to suppress the occurrence of wrinkles.

### Manufacturing Method

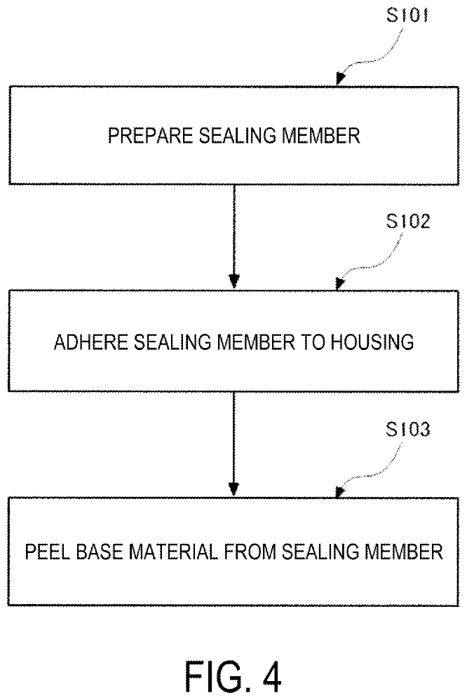

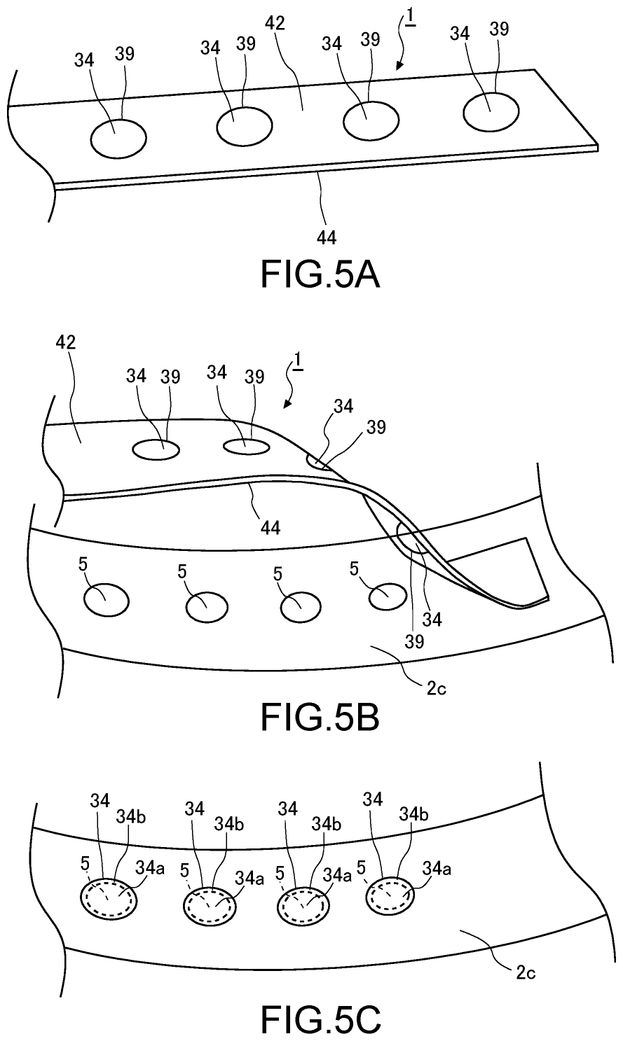

Next, a method for manufacturing the gas generator 1 according to the present example will be described using FIG. 4 and FIG. 5. The gas generator 1 according to the present example is characterized by the closing member 34 and thus the closing of the gas discharge ports 5 by the closing members 34 in the present example will now be described.

FIG. 4 is a flowchart illustrating an order of the closing of the gas discharge ports 5 by the closing members 34 in the method for manufacturing the gas generator 1 according to the present example. Hereinafter, the closing process in the present example is described below using FIG. 5 and with reference to FIG. 4. In the present example, first, a sealing member 40 for forming the closing members 34 is prepared. FIG. 5(a) is a perspective view illustrating the sealing member 40. The sealing member 40 includes a base material 42 formed into a rectangular shape. As the base material 42, aluminum foil having a thickness of about 50 to 100 μm is used. Note that, as the base material 42, a metal foil other than the aluminum foil may be used. In the present example, an adhesive layer 44 is formed on one surface of the base material 42 (back surface in the state illustrated in FIG. 5(a)). The adhesive layer 44 is a joining surface capable of joining the sealing member 40 to the wall surface of the housing 4. Thus, the base material 42 includes a joining surface capable of being joined to the wall surface of the housing 4. Note that, in the stage before the sealing member 40 is adhered to the housing 4 of the gas generator 1, the adhesive layer 44 is covered with peelable peel-off paper (not illustrated).

Further, a plurality of the closing members 34 are formed on the base material 42. Each of the plurality of closing members 34 is independently formed correspondingly to each of the plurality of gas discharge ports 5 provided to the wall surface of the peripheral wall 2c. Specifically, the plurality of closing members 34, each having a diameter greater than a diameter of the gas discharge ports 5 by 1 mm to 5 mm are formed in the base material 42. For example, the closing member 34 is formed by inserting a notch 39 illustrated in FIG. 5(a) from a surface of the base material 42 (surface on a side opposite to a formation surface of the adhesive layer 44) without penetrating the adhesive layer 44. The plurality of closing members 34 can be formed from a single sealing member 40, and the outer shape of the closing member 34 can be defined by the notch 39. Note that a portion of the notch 39 may penetrate the adhesive layer 44. With the notch 39, each of the plurality of closing members 34 is formed coupled to the base material 42 at a strength lower than a strength of the base material 42. In this way, in the present example, as illustrated in FIG. 4, the sealing member 40 in which the plurality of closing members 34 are formed is prepared (step S101).

In step S102 following step S101, the sealing member 40 is adhered to the housing. Using FIG. 5(b), the adhering of the sealing member 40 thus prepared to the wall surface of the housing 4 will be described. For the purpose of explanation, FIG. 5(b) extracts and illustrates a portion of the peripheral wall 2c and four gas discharge ports 5 formed on the wall surface of the peripheral wall 2c.

In the present example, the plurality of closing members 34 are formed on the sealing member 40 correspondingly to the arrangement pattern of the plurality of gas discharge ports 5. Further, the outer shape of the closing member 34 and the gas discharge port 5 are both formed into a circular shape. In the adhering of the sealing member 40, the sealing member 40 is adhered to the wall surface of the peripheral wall 2c with each of the plurality of closing members 34 formed on the sealing member 40 respectively corresponding to each of the plurality of gas discharge ports 5. More specifically, after the sealing member 40 is positioned onto the wall surface of the peripheral wall 2c with the center of each of the plurality of closing members 34 respectively coinciding with the center of each of the plurality of gas discharge ports 5, the sealing member 40 is adhered to the wall surface. Thus, an outer periphery of the predetermined width of the closing member 34 formed on the base material 42 is joined to the wall surface of the peripheral wall 2c. The region joined to the peripheral wall 2c of the closing member 34 is the joining region 34b.

In step S103 following step S102, the base material 42 is peeled from the sealing member 40 adhered to the wall surface of the peripheral wall 2c. Each of the joining regions 34b of the plurality of closing members 34 formed on the base material 42 is joined to the wall surface of the peripheral wall 2c, and thus the base material 42 is peeled, leaving each of the closing members 34 on the wall surface of the peripheral wall 2c. Each of the plurality of closing members 34 is joined to the base material 42 at a strength lower than the strength of the base material 42 by the notch 39 and thus, for example, by peeling the base material 42 while pressing each of the plurality of closing members 34, it is possible to peel off the base material 42 while leaving the plurality of closing members 34 on the wall surface of the peripheral wall 2c. FIG. 5(c) illustrates the state after the base material 42 has been peeled. Each of the plurality of gas discharge ports 5 are respectively closed by the plurality of closing members 34 left on the wall surface of the peripheral wall part 2c. Thus, in the present example, the plurality of gas discharge ports 5 are each closed while the base material 42 is peeled from the sealing member 40 adhered to the wall surface of the peripheral wall 2c, leaving each of the plurality of closing members 5 on the wall surface of the peripheral wall 2c with the respective joining regions 34b of the plurality of closing members 34 joined to the wall surface of the peripheral wall 2c.

In the present example, after the single sealing member 40 is adhered to the housing 4, the base material 42 is peeled from the sealing member 40, respectively closing each of the plurality of gas discharge ports 5 by each of the plurality of closing members 34. This makes it possible to shorten the time required for attaching the closing members 34, and complete the closing of the gas discharge ports 5 in a short amount of time. Further, according to the gas generator 1 manufactured by the present example, the joining region 34b is not provided wider than necessary for ensuring the air tightness of the internal space of the housing 4, and therefore the closing member 34 can be attached without being widely formed, making it possible to reduce the possibility of the melting of the closing member 34 and suppress the melting of the closing member 34 and the release thereof to outside the gas generator 1 during combustion of the gas generating agents 22, 26.

### Modified Example 1

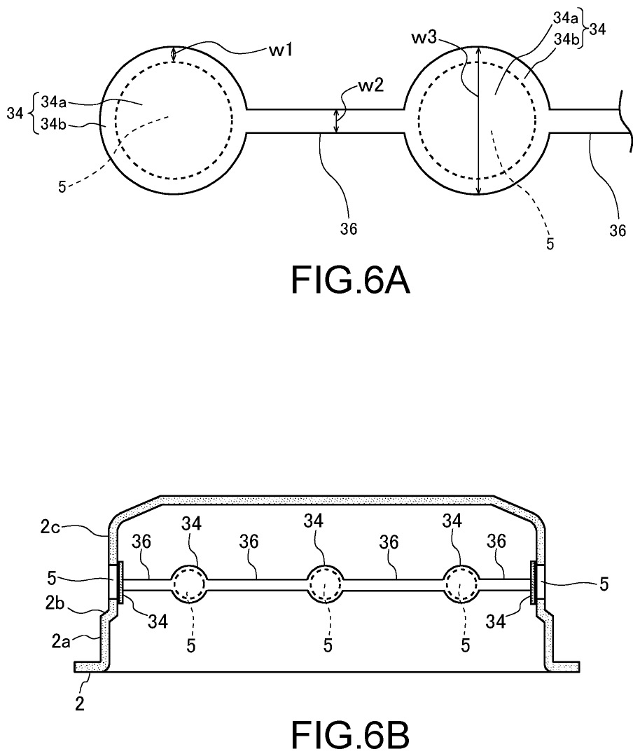

Next, a modified example of the gas generator 1 will be described using FIG. 6. The gas generator 1 according to the present modified example is characterized in that the closing members 34 adjacent to each other are connected by a connecting member 36. FIG. 6(a) is an extracted, enlarged plan view illustrating two gas discharge ports 5 and two closing members 34 provided to the wall surface of the upper shell 2 defining the first combustion chamber 21. FIG. 6(b) is a cross-sectional view illustrating the upper shell 2 and the closing members 34 extracted from the cross-sectional view in the height direction of the gas generator 1 illustrated in FIG. 1. In FIGS. 6(a) and (b), similar to FIGS. 2(a) and (b), a region surrounded by a dotted line is the gas discharge port 5.

As illustrated in FIG. 6(a), in the present modified example, the closing members 34 adjacent to each other are connected by the connecting member 36. The connecting member 36 is integrally formed with the plurality of closing members 34 using the same material as that of the closing member 34. The connecting member 36 has a horizontally long rectangular shape having a longitudinal direction corresponding to the circumferential direction of the housing 4. As with the closing member 34, the connecting member 36 has an adhesive layer formed on one surface thereof, and is adhered to the wall surface of the housing 4 by the adhesive layer. A width w2 of the connecting member 36 is less than a width w3 of the closing member 34. Here, the width w2 of the connecting member 36 is a direction substantially orthogonal to the arrangement direction of the closing member 34 and the connecting member 36. In the present example, the width w2 of the connecting member 36 is a length in a short-side direction of the connecting member 36. Note that the arrangement direction of the closing member 34 and the connecting member 36 is the circumferential direction of the housing 4. The width w3 of the closing member 34 is a length in a direction substantially orthogonal to the arrangement direction of the closing member 34 and the connecting member 36 and, in the present example, the outer shape of the closing member 34 is a circular shape, and thus the width w3 of the closing member 34 is the diameter of the closing member 34. Note that the width w3 in a case where the closing member 34 has a polygonal shape is a length from one end to the other end of the polygonal shape, passing through the center of the polygonal shape.

Further, as illustrated in FIG. 6(b), each of the plurality of gas discharge ports 5 is arranged in the circumferential direction of the housing 4, and the plurality of closing members 34 are integrated by the adjacent closing members 34 being connected by the connecting members 36. The plurality of closing members 34 are each joined to the wall surface of the peripheral wall 2c by the joining region 34b thereof and the connecting member 36. Similar to the first example described above, the gas generator 1 according to the present modified example includes eight gas discharge ports 5 and closing members 34. In this case, for example, four closing members 34 may be integrally formed by being connected by three connecting members, and eight gas discharge ports 5 may be closed using two of these.

According to the gas generator 1 according to the present modified example, the closing members 34 can be attached to the wall surface of the housing 4 by the joining regions 34b and the connecting members 36, making it possible to firmly fix the closing members 34 to the wall surface of the housing 4. Further, according to the gas generator 1 according to the present modified example, the width of the connecting member 36 is smaller than the width of each of the plurality of closing members 34, and therefore an area of the closing members 34 and the connecting members 36 can be smaller than an area of the sealing tape having a strip shape, and an area of the closing members 34 and the connecting members 36 that may melt can be reduced, making it possible to close the gas discharge ports 5 by the closing members 34 and suppress the melting of the closing members 34 and the connecting members 36 and the release thereof to outside the gas generator 1 during combustion of the gas generating agents 22, 26. Furthermore, because the plurality of closing members 34 are integrally formed by being connected by the connecting members 36, the plurality of closing members 34 can be easily handled. Furthermore, a flexibility of the connecting member 36 can be utilized to make the occurrence of distortion and displacement of the closing member 34, which may arise during adherence of the closing member, less likely, making it possible to suppress the occurrence of wrinkles and gaps between the closing member 34 and the wall surface of the peripheral wall 2c after the closing member 34 is completely adhered compared to a case where a sealing tape having a strip shape and a constant width is used to close the gas discharge ports 5.

### Modified Example 2

Further, in the gas generator 1, the closing member 34 may be attached to an outer wall surface of the housing 4 to close the gas discharge port 5. When the gas generator 1 having such a configuration is used for the drive source of an airbag device, the airbag is folded in the vicinity of the gas discharge ports 5 prior to actuation of the gas generator 1. In this case, when the gas generator 1 is actuated and the combustion gas is supplied from the gas discharge ports 5 to the airbag, the possibility exists that the high-temperature combustion gas will come into contact with the outer peripheral surface of the housing 4 in the vicinity of the gas discharge ports 5. As a result, melting may occur in the joining region 34b of the closing member 34 joined to the outer peripheral surface of the peripheral wall 2c of the housing 4. However, the joining region 34b is not provided wider than necessary, and therefore the possibility that the joining region 34b will melt can be reduced. The gas generator 1 is capable of closing the gas discharge ports 5 by the closing members 34 and suppressing the melting of the closing members 34 and the release thereof to outside the gas generator 1 during combustion of the gas generating agents 22, 26. Thus, when the gas generator 1 is utilized as a power source of an airbag device, it is possible to suppress the release of a melted closing member into the airbag. Further, the closing of the gas discharge ports 5 illustrated in FIG. 4 and FIG. 5, and the closing member 34 and the connecting member 36 illustrated in FIG. 6 can of course be applied to the gas generator 1 having such a configuration.

### Second Example

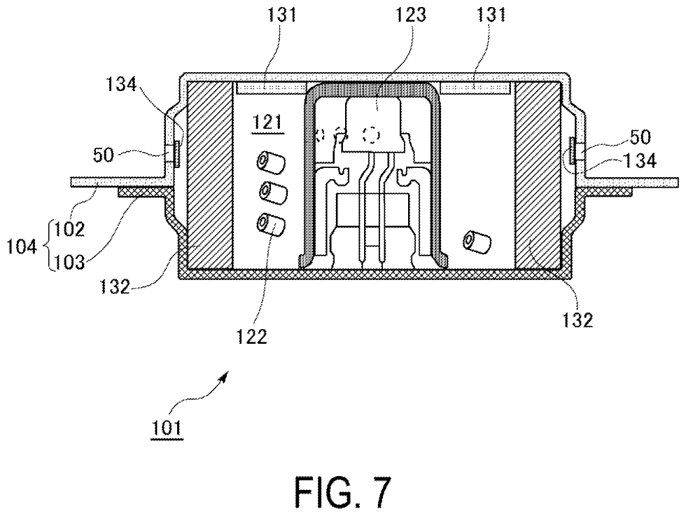

A gas generator 101 of a second example will be described using FIG. 7. FIG. 7 is a cross-sectional view in a height direction of the gas generator 101 of the present example. The gas generator 101 illustrated in FIG. 7 is configured as a single-type gas generator in which only one combustion chamber 121 and one igniter 123 are accommodated inside the housing 104 that includes an upper shell 102 and a lower shell 103 and is formed by being fixed by welding at a flange portion. Thus, the technique of the present disclosure can of course be applied to a single-type gas generator as well.

The igniter 123 is disposed in a central portion of an internal space of the housing 104. A lower end of the igniter 123 is joined to a bottom surface of the lower shell 103, and an upper end of the igniter 123 comes into contact with a top surface of the upper shell 102. Thus, a space having an annular shape and surrounding the igniter 123 is formed in the internal space of the housing 104. The combustion chamber 121 is configured in this space, and is filled with a gas generating agent 122. The gas generating agent 122 is filled in a state of being pressed against the bottom surface of the lower shell 103, the filter 132, and the like by a biasing force of a cushion 131, ensuring that vibration does not occur unnecessarily inside the first combustion chamber 121. Then, the filter 132 having an annular shape is disposed between the combustion chamber 121 and gas discharge ports 50 formed in the wall surface of the housing 4 defining the combustion chamber 121. As the filter 132, a filter similar to the filter 32 of the first example described above can be used.

The area surrounding the igniter 123 may be filled with a transfer charge. As the transfer charge, a transfer charge similar to that of the first example described above can be used. The gas generator 101 according to the present example includes the igniter 123 as an ignition device. The ignition device may be constituted by the igniter 123 only, or may be configured to include the igniter 123 and the transfer charge.

In addition, to prevent outside air containing moisture from entering the housing 104 from the outside, the gas discharge ports 50 are closed, by closing members 134, from inside the housing until the gas generator 101 is actuated. In the present example, the closing member 134 is attached to an inner wall surface of the upper shell 102, closing the gas discharge port 5 from inside the housing 104. The configurations of the gas discharge port 50 and the closing member 134 are the same as those of the gas discharge port 5 and the closing member 34 in the first example described above, and thus detailed descriptions thereof will be omitted. The gas generator 101 according to the present example is capable of closing the gas discharge ports 50 by the closing members 134 and suppressing the melting of the closing members 134 and the release thereof to outside the gas generator 101 during combustion of the gas generating agent 122.

Note that, in the single-type gas generator 101 described above, the closing of the gas discharge ports illustrated in FIG. 4 and FIG. 5 may be applied. Further, in the gas generator 101, the closing member 34 and the connecting member 36 of the modified example of the first example described above may of course be applied. In addition, in the gas generator 101, the closing member 34 may of course be attached to an outer wall surface of the housing 104 to close the gas discharge ports 50.

Note that the gas generators according to the examples and the modified examples described above have a disc shape in which a length in the axial direction (height direction) is shorter than an outer diameter in the top view. However, for example, the technique of the present disclosure may be applied to a gas generator having a cylindrical shape in which the length in the axial direction is longer than the outer diameter in the top view. In a gas generator having a cylindrical shape, the plurality of gas discharge ports are formed in the housing, and each of the plurality of gas discharge ports are disposed side by side in the axial direction of the housing. In the gas generator having such a configuration as well, the plurality of closing members of the examples described above may be used to respectively close the plurality of gas discharge ports. In addition, in the gas generator having such a configuration as well, the gas discharge ports may of course be closed by the closing illustrated in FIG. 4 and FIG. 5, or the gas discharge ports may of course be closed by the closing members 34 illustrated in FIG. 6.

### REFERENCE SIGNS LIST

1, 101 Gas generator
2, 102 Upper shell
3, 103 Lower shell
4, 104 Housing
5, 50 Gas discharge port
10 Divider wall
14 Dividing wall
16 Accommodating wall member
21 First combustion chamber
22 First gas generating agent
23 First igniter
25 Second combustion chamber
26 Second gas generating agent
27 Second igniter
31, 35 Cushion
32, 132 Filter
34, 134 Closing Member
36 Connecting member

1. A gas generator, comprising:
a housing;
a combustion chamber accommodating therein a gas generating agent to be burned by an ignition device provided in the housing;
a plurality of gas discharge ports provided to a wall surface that defines the combustion chamber, and configured to communicate an inside and an outside of the combustion chamber; and
a plurality of closing members configured to respectively close the plurality of gas discharge ports,
each of the plurality of closing members including,
a covering region configured to cover a corresponding gas discharge port of the plurality of gas discharge ports and
a joining region configured to be joined to the wall surface and formed adjacent to and surrounding the covering region, and
the joining region of each of the plurality of closing members being joined to the wall surface at a width within a range from 1 mm to 5 mm, inclusive, from a peripheral edge of the corresponding gas discharge port, and without interfering with another joining region.

2. The gas generator according to claim 1, wherein
each of the plurality of closing members has an outer shape similar to a shape of each of the plurality of gas discharge ports.

3. The gas generator according to claim 1, wherein
each of the plurality of closing members is attached to the wall surface on a side of the combustion chamber.

4. The gas generator according to claim 1, wherein
each of the plurality of closing members has a center position that coincides with a center position of the corresponding gas discharge port.

5. The gas generator according to claim 1, wherein
each of the plurality of gas discharge ports is disposed in a circumferential direction of the housing,
each of the plurality of closing members is joined to the wall surface by the joining region of the closing member and by a connecting member in a state where adjacent closing members of the plurality of closing members are connected and integrated by the connecting member, and
the connecting member has a width smaller than a width of each of the plurality of closing members.

6. The gas generator according to claim 1, wherein
each of the plurality of closing members is a sealing tape.

7. A method for manufacturing the gas generator according to claim 1, comprising:
preparing a sealing member provided with, on a base material including one surface provided with a joining surface that can be joined to the wall surface, the plurality of closing members independently formed correspondingly to each arrangement of the plurality of gas discharge ports provided to the wall surface, each of the plurality of closing members being formed by being coupled to the base material at a strength lower than a strength of the base material;
adhering the sealing member to the wall surface with each of the plurality of closing members formed on the sealing member made to respectively correspond to the plurality of gas discharge ports; and
closing each of the plurality of gas discharge ports while peeling the base material from the sealing member adhered to the wall surface, leaving each of the plurality of closing members on the wall surface with the joining region of each of the plurality of closing members joined to the wall surface.

8. The gas generator according to claim 2, wherein
each of the plurality of closing members is attached to the wall surface on a side of the combustion chamber.

9. The gas generator according to claim 2, wherein
each of the plurality of closing members has a center position that coincides with a center position of the corresponding gas discharge port.

10. The gas generator according to claim 2, wherein
each of the plurality of gas discharge ports is disposed in a circumferential direction of the housing,
each of the plurality of closing members is joined to the wall surface by the joining region of the closing member and by a connecting member in a state where adjacent closing members of the plurality of closing members are connected and integrated by the connecting member, and
the connecting member has a width smaller than a width of each of the plurality of closing members.

11. The gas generator according to claim 4, wherein
each of the plurality of gas discharge ports is disposed in a circumferential direction of the housing,
each of the plurality of closing members is joined to the wall surface by the joining region of the closing member and by a connecting member in a state where adjacent closing members of the plurality of closing members are connected and integrated by the connecting member, and
the connecting member has a width smaller than a width of each of the plurality of closing members.

12. The gas generator according to claim 2, wherein
each of the plurality of closing members is a sealing tape.

13. The gas generator according to claim 4, wherein
each of the plurality of closing members is a sealing tape.

14. The gas generator according to claim 5, wherein
each of the plurality of closing members is a sealing tape.

15. A method for manufacturing the gas generator according to claim 2, comprising:
preparing a sealing member provided with, on a base material including one surface provided with a joining surface that can be joined to the wall surface, the plurality of closing members independently formed correspondingly to each arrangement of the plurality of gas discharge ports provided to the wall surface, each of the plurality of closing members being formed by being coupled to the base material at a strength lower than a strength of the base material;
adhering the sealing member to the wall surface with each of the plurality of closing members formed on the sealing member made to respectively correspond to the plurality of gas discharge ports; and
closing each of the plurality of gas discharge ports while peeling the base material from the sealing member adhered to the wall surface, leaving each of the plurality of closing members on the wall surface with the joining region of each of the plurality of closing members joined to the wall surface.

16. A method for manufacturing the gas generator according to claim 4, comprising:
preparing a sealing member provided with, on a base material including one surface provided with a joining surface that can be joined to the wall surface, the plurality of closing members independently formed correspondingly to each arrangement of the plurality of gas discharge ports provided to the wall surface, each of the plurality of closing members being formed by being coupled to the base material at a strength lower than a strength of the base material;
adhering the sealing member to the wall surface with each of the plurality of closing members formed on the sealing member made to respectively correspond to the plurality of gas discharge ports; and
closing each of the plurality of gas discharge ports while peeling the base material from the sealing member adhered to the wall surface, leaving each of the plurality of closing members on the wall surface with the joining region of each of the plurality of closing members joined to the wall surface.
